(19) United States
(12) Patent Application Publication
(10) Pub. No.: US 2011/0138980 A1
(43) Pub. Date: Jun. 16, 2011

(54) PUNCHING UNIT

(75) Inventors: Kazuo NISHIMURA, Kaga (JP); Toshiyuki Majima, Kaga (JP); Megumi Ichikawa, Kaga (JP); Susumu Ishii, Kawasaki-shi (JP)

(73) Assignees: DAIDO KOGYO CO., LTD., Kaga (JP); SEIKO CO., LTD., Kawasaki-shi (JP)

(21) Appl. No.: 12/957,888

(22) Filed: Dec. 1, 2010

(30) Foreign Application Priority Data
Dec. 10, 2009 (JP) 2009-280686

(51) Int. Cl. B23D 25/12

(52) U.S. Cl. 83/345

(57) ABSTRACT

The invention provides a rotary-type punching unit that solves a problem of a prior art rotary-type punching unit that its punching torque is highly peaked in beginning and ending punching, thus disabling to punch a heavy paper or the like and degrading the quality level of punch holes. A blade surface of a punch of the invention is formed as an inclined surface inclined with respect to the outer peripheral surface of a punch shaft or of a die shaft such that a leading edge thereof is higher than a trailing edge with an inclination angle within a range of 5° to 15° (preferably 10°). A die surface of the die is formed into a surface of a circular arc centering on a rotational axis of the shafts. Thereby, the peaks of the punching torque are reduced and the quality level of the punch hole is kept high.

### CROSS REFERENCE TO RELATED APPLICATION

This application claims the foreign priority benefit under Title 35, United States Code, §119 (a)-(d) of Japanese Patent Application No. 2009-280686, filed on Dec. 10, 2009 in the Japan Patent Office, the disclosure of which is herein incorporated by reference in its entirety.

### BACKGROUND OF THE INVENTION

1. Field of the Invention

The present invention relates to a punching unit mounted to an image forming apparatus such as a copier, a printer and the like for punching holes through sheets of printed paper and more specifically to a rotary-type punching unit.

2. Related Art

Hitherto, there is known a rotary-type punching unit having punch and die shafts disposed in parallel from each other and respectively having pluralities of punches and dies and punching holes through sheets of paper by engaging the punches of the punch shaft with the dies of the die shaft by rotating the punch and die shafts.

As shown in FIG. 8B, the rotary-type punching unit has a punch 13′ and a die 22′ whose edge surfaces, i.e., a blade surface 13′a of the punch and a die surface 22′a of the die, are formed of plane surfaces that are orthogonal to radial lines r respectively passing through rotational axes O of the shafts. The rotary-type punching unit begins a sheet punching stroke by engaging the leading edge of the blade surface 13′a of the punch with that of the die surface 22′a (Begin Punching), proceeds the stroke by fully engaging the blade surface 13′ a with the die surface 22′a by synchronously rotating the both shafts while conveying the sheets of paper (During Punching) and ends the stroke by engaging the trailing edge of the blade surface 13′a with that of the die surface 22′a (End Punching).

While a sheet punching torque T varies as shown in FIG. 8A in the series of steps of the punching stroke following to a rotational angle α of the punch and die shafts that rotate in synchronism, the punching torque T peaks largely just after beginning and just before ending the punching (in beginning to cut and in ending the cut).

Hitherto, Japanese Patent No. 3257405 has proposed a device that reduces such peak torques. The device is arranged such that the blade surface of a punch is formed into a convex surface whose front and rear portions in the rotational direction are inclined toward the center of rotation and whose front portion is moderately inclined as compared to the rear portion. Because the blade surface of the punch is formed into the convex surface, a relative angle (shearing angle) of the blade surface of the punch with the die surface of the die right after beginning of the engagement is close to parallel as compared to that of another device whose punch blade surface is flat. Accordingly, a cutting length per unit rotational angle from the beginning of the engagement to the intermediate point of a punching stroke increases and a cutting length in the latter half of the punching stroke is shortened. Thereby, the punching unit of Japanese Patent No. 3257405 averages the punch hole cutting length per unit rotational angle from the beginning of the engagement to the full engagement of the punch with the die and lowers the peaks of the punching torque.

However, although the punching unit of Japanese Patent No. 3257405 permits to reduce driving torques of the punch and die and to downsize a driving mechanism by reducing the peaks of the punching torque and lowering the rigidity of the punch and die, it has problems that because the shape of the blade surface of the punch is complicated, it is difficult to fully reduce the punching torque or the torque in ending cutting in particular due to a clearance between the punch and the die in engagement.

While a large and high-performance copier enabling light-printing and book-binding is been realized lately and a color hard paper whose surface is coated and a heavy paper for use as a cover sheet and a spine of a book are often used in such copier, the punching unit described above has problem that it is difficult to punch holes through the color paper and heavy paper described above because it is limited to enhance a motor and rigidity of the punching unit from the aspects of capacity of power and cost of the copier.

Still more, the punching unit having the punch whose blade surface is formed into the convex surface has a problem that because the clearance with the die must be widened, the punching unit drops its sharpness and generates fluff at a cut edge, thus degrading the quality level of holes as a result.

### SUMMARY OF THE INVENTION

Accordingly, the present invention aims at solving the problems de scribed above by providing a punching unit which is capable of keeping punch holes in a high quality level and remarkably reducing peaks of the punching torque by fabricating punches and dies in high precision with relatively simple shapes and by keeping an engagement clearance of the punch and die in optimum along the whole engagement of the punch with the die.

According to the invention, a punching unit has a punch shaft provided with punches on the outer peripheral surface thereof and a die shaft provided with dies at positions corresponding to the punches and punches holes through sheets of paper by engaging the punches with the dies by rotating the punch and die shafts in synchronism and in the directions opposite from each other;

wherein either one of the blade surface of the punch or the die surface of the die is formed of an inclined surface inclined with respect to the outer peripheral surface of the punch shaft or of the die shaft such that the side of a leading edge in the rotational direction is higher than the side of a trailing edge with an inclination angle in a range of 5° to 15°.

By constructing the invention as described above, either one of the blade surface of the punch or the die surface of the die that engage from each other is formed of the inclined surface inclined with respect to the outer peripheral surface of the punch shaft or of the die shaft such that the side of the leading edge is higher than the side of the trailing edge, so that it becomes possible to reduce peaks of punching torque in punching sheets. Accordingly, it becomes possible to punch holes even through a color sheet of paper and a heavy sheet for use as a cover sheet or a spine of a book for example by using a motor having a relatively small torque capacity.

Still more, because the invention may be made by the relatively simple arrangement of inclining the blade surface of the punch or the die surface of the die with a certain angle, the punching unit may be manufactured readily at high precision. It also allows the clearance of the blade surface and the die surface in engaging from each other to be adequately maintained and the quality level of punch holes to be improved.

If the inclination angle of the inclined surface is 5° or less, the effect of reducing the peaks of the punching torque becomes insufficient and it is unable to accurately and steadily punch holes through a heavy paper or the like by a motor within a range stipulated by a space or the like. If the inclination angle is 15° or more, the rotational angle of the shaft during the punching state becomes too large, the clearance for preventing the punch from interfering with the die is enlarged and it becomes difficult to keep the punch holes in the high quality level. The punching of the heavy paper or the like enabled by reducing the peaks of the punching torque and the improvement of the quality level of the punch holes may be both achieved by keeping the inclination angle within the range from 5° to 15°.

Preferably, the other one of the blade surface of the punch or the die surface of the die is formed into a convex circular arc surface whose level at the center part in the rotational direction is high.

Accordingly, because the other one of the blade surface of the punch or the die surface of the die is formed of the convex circular arc surface, it is possible to reduce the peaks of the punching torque further by proceeding the shearing of the sheets along the circular arc surface in engaging the punch with the die. It becomes also possible to reduce the clearance that is indispensable for preventing the interference of the punch with the die during punching associated with the rotation by reducing the rotational angle of the shaft during punching. Then, it permits to achieve the both downsizing of the punching unit enabled by reducing the maximum punching torque and keeping of the high quality level of the punch holes.

More preferably, the blade surface of the punch is formed of the inclined surface and the die surface of the die is formed of the circular arc surface.

Thereby, because the blade surface of the punch is formed of the inclined surface and the die surface of the die is formed of the circular arc surface, the optimum combination is brought out in terms of manufacturing, the punching torque and the quality level of the punch holes.

Preferably, the blade surface of the punch is formed of the inclined surface and the center part of the inclined surface is concaved as shown in FIG. 3C for example.

Thereby, because the center part of the inclined surface of the blade surface of the punch is concaved, the blade surface that engages with the die surface may be sharpened, the edge of the punch may be lightened and the punch hole may be perforated quickly. Thus, the punching unit of the invention may be readily accommodated to speed-up of a copier or the like.

Preferably, the inclination angle is 10°.

Because the inclination angle of the inclined surface is set at the optimum angle of 10°, it becomes possible to reduce the peaks of the punching torque, to punch through a heavy paper or the like by a small motor, to perforate punch holes in high quality level accurately and steadily and to improve the reliability of the punching unit.

Preferably, the circular arc surface is a surface of a circular arc centering on the rotational axis of the die shaft or of the punch shaft.

Thereby, because the circular arc surface is formed as the surface of the circular arc centering on the rotational axis of the shaft and the engagement of the punch with the die proceeds as if the punch rolls along the circular arc surface, the shearing angle formed between the punch blade surface and the die surface is always maintained and the punching of the sheet may be proceeded smoothly. It then allows the peaks of the punching torque to be reduced and the punch holes in the high quality to be always formed.

It is noted that the summary of the invention described above does not necessarily describe all necessary features of the invention. The invention may also be a sub-combination of the features described above.

### BRIEF DESCRIPTION OF DRAWINGS

FIG. 1 is a front view illustrating an embodiment of a punching unit to which the invention may be applied;

FIG. 2 is a diagram illustrating respectively different states of punching carried out by a punch and a die of the invention;

FIG. 3A is an enlarged schematic diagram showing the punch and die of the invention, FIG. 3B is a diagrammatic view showing blade surfaces of the punches and FIG. 3C is a section view showing the blade surface of the punch according to a different embodiment of the invention;

FIGS. 4A, 4B and 4C are diagrams for explaining differences between a prior art punching unit and the punching unit of the invention, wherein FIG. 4A shows a length of cut S in beginning to cut a sheet of paper, FIG. 4B shows a cutting (shaft) rotational angle α in ending to cut the sheet and FIG. 4C illustrates the shaft rotational angle α and a cutting position (rotational angle) β;

FIG. 5 is a graph showing punching torque curves with respect to the shaft rotational angle α;

FIG. 6 is a diagram illustrating different states of punching, similarly to FIG. 2, according to a different embodiment in which the die surface of the die is flattened;

FIG. 7 is an enlarged diagrammatic view showing the die surface of the die; and

FIGS. 8A and 8B are diagrams illustrating operations of the prior art punching unit, wherein FIG. 8A shows a punching torque curve and FIG. 8B schematically shows a punch and a die.

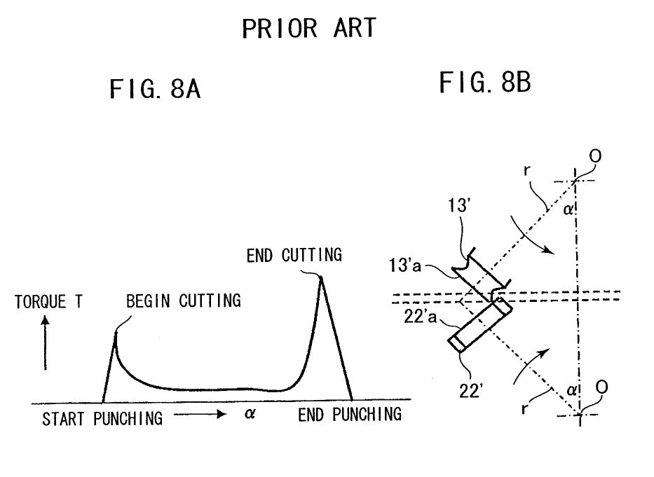

### PREFERRED EMBODIMENTS OF THE INVENTION

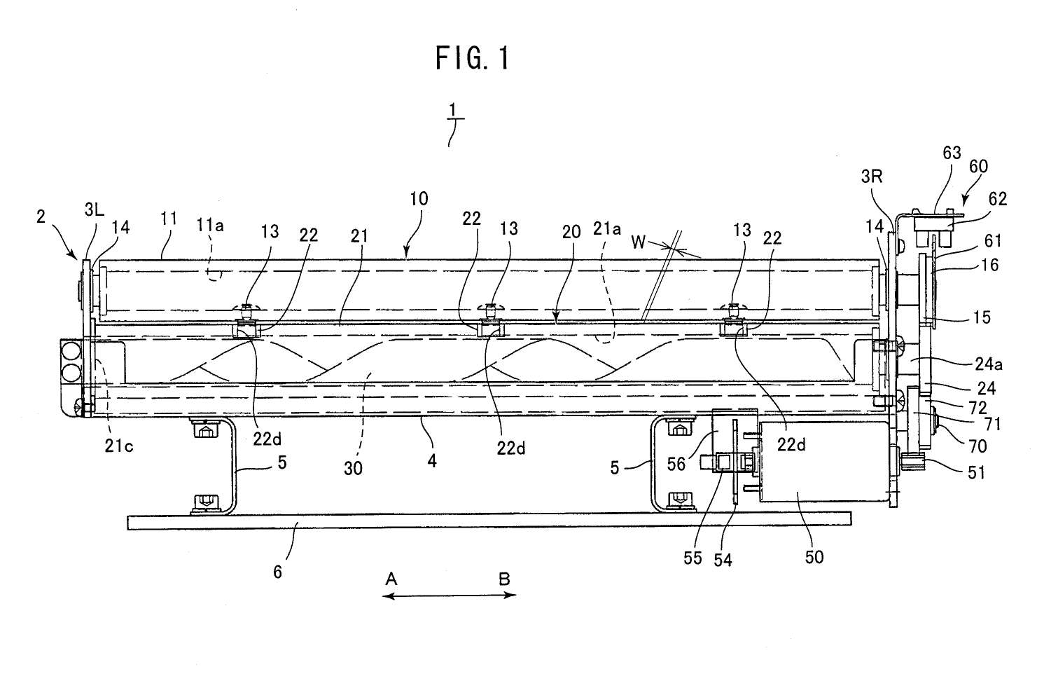

Embodiments of a punching unit of the invention will be explained below with reference to the drawings. As shown in FIG. 1, the punching unit 1 has a base 6 fixed to a frame of an image forming apparatus (including a post-processing unit) such as a printer, a copier and the like and a bottom plate 4 is fixed to the base 6 by bolts through the intermediary of a plurality of legs 5. Right and left side plates 3R and 3L are fixed to the right and left ends of the bottom plate 4 and a frame 2 is composed of the bottom plate 4, the side plates 3R and 3L thus fixed in a body. Then, a punch shaft 10 and a die shaft 20 are disposed in parallel between the side plates 3R and 3L that rotatably support the both ends of the shafts. The punch and die shafts 10 and 20, together with the frame 2, are structural members (strength members) of the punching unit 1. It is noted that the punch and die shafts 10 and 20 are supported by the side plates 3R and 3L with a predetermined gap W that forms an engagement clearance through which sheets of paper pass.

The punch shaft 10 is composed of a punch shaft body 11 formed of a hollow cylindrical member made of light metal alloy such as aluminum alloy and punch axial portions provided on the both ends of the shaft body 11. Punches 13 are provided at a plurality of places, e.g., three places, of the punch shaft body 11 in the axial direction thereof (in the directions of arrows A and B in FIG. 1) so as to protrude from the outer peripheral surface of the shaft while being retained in a hollow portion 11a, i.e., the inside of the cylindrical shaft.

The punch axial portions are attached to the side plates 3R and 3L so as to close openings on the sides of the punch shaft body 11 and to be rotatably supported through the intermediary of bearings 14. A punch gear 15 for transmitting a driving force to the punch shaft 10 is secured to the punch axial portion in the direction of the arrow B in FIG. 1 (the direction of the arrow A in FIG. 1 will be referred to as the left direction and that of the arrow B as the right direction hereinafter) and an antibacklash gear 16 is attached adjacently with the punch gear 15 while its phase being adjusted. The gear 16 is attached with a detecting plate 61 that composes a punching position detector 60.

The punching position detector 60 includes the detecting plate 61 and punching position detecting sensors 62 composed of photo sensors and attached to an L-shaped bracket 63 fixed to the upper part of the right side plate 3R. The punching position detector 60 detects that the punch 13 is located at the punching position when the detecting plate 61 passes between the punching position detecting sensors 62.

Meanwhile, the die shaft 20 is also formed of light alloy metal such as aluminum alloy similarly to the punch shaft 10 and has a die shaft body 21 formed of a hollow cylindrical member. The die shaft body 21 is provided with dies 22 on the outer periphery thereof at three positions in the axial direction (in the directions of the arrows A and B in FIG. 1) corresponding to the punches 13 of the punch shaft 10. Each die 22 has a die hole 22d penetrating in the radial direction from the outer peripheral surface to a hollow portion 21a of the die shaft body 21.

A right die axial portion of the die shaft body 21 is rotatably supported by the right side plate 3R through the intermediary of bearings and a left die axial portion thereof is rotatably supported by the left side plate 3L through the intermediary of bearings in the same manner. The right die axial portion is composed of a boss portion 24a of a die gear 24 that engages with the punch gear 15 and the antibacklash gear 16. A double-shaft type electric motor 50 is mounted under the lower end part of the right side plate 3R. A pinion 51 is fixed to one output shaft of the motor and a detector 54 of a pickup sensor 55 is fixed to the other output shaft. The pickup sensor 55 is attached to a bracket 56 fixed to the bottom plate 4 and is capable of detecting a number of revolutions of the electric motor 50. The right side plate 3R is attached with an intermediate shaft 70 supporting two intermediate gears 71 and 72. One intermediate gear 71 engages with the pinion 51 and the other intermediate gear 72 engages with the die gear 24.

A chip discharging screw plate 30 is fittingly inserted into the hollow portion 21a of the die shaft body 21. The screw plate 30 is disposed so that one end thereof is rotatably fixed to the right side plate 3R and so that the other end faces to an opening 21c located at the left side plate 3L. A plate-like member is twisted to form the screw plate 30 into the shape of a screw. The screw plate 30 rotates relatively with respect to the rotating die shaft 20 to convey punched chips produced from the dies 22 in the direction of the arrow A within the hollow portion 21a based on the relative rotation and to discharge them out of the hollow portion 21a from the opening 21c.

The punching unit 1 is constructed as described above and is attached to a large-size copier for example. The electric motor 50 is driven so that it is coordinated with the conveyance of sheets of paper on which images have been formed by the copier. The revolution of the motor is transmitted to the die shaft 20 through the intermediary of the pinion 51, the intermediate gears 71 and 72 and the die gear 24 and to the punch shaft 10 through the punch gear 15 and the antibacklash gear 16. Thereby, the die shaft 20 and the punch shaft 10 rotate with timing coordinated with the conveyance of the sheets in the opposite directions with phases accurately synchronized to punch holes at predetermined places by the punches 13 and dies 22.

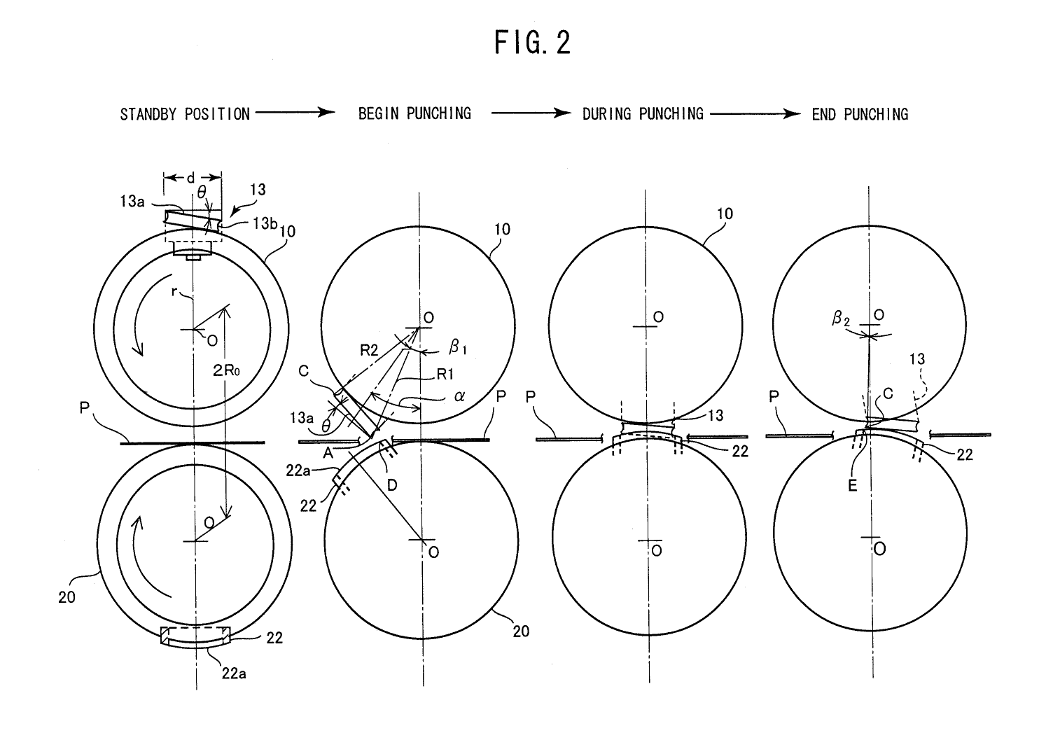

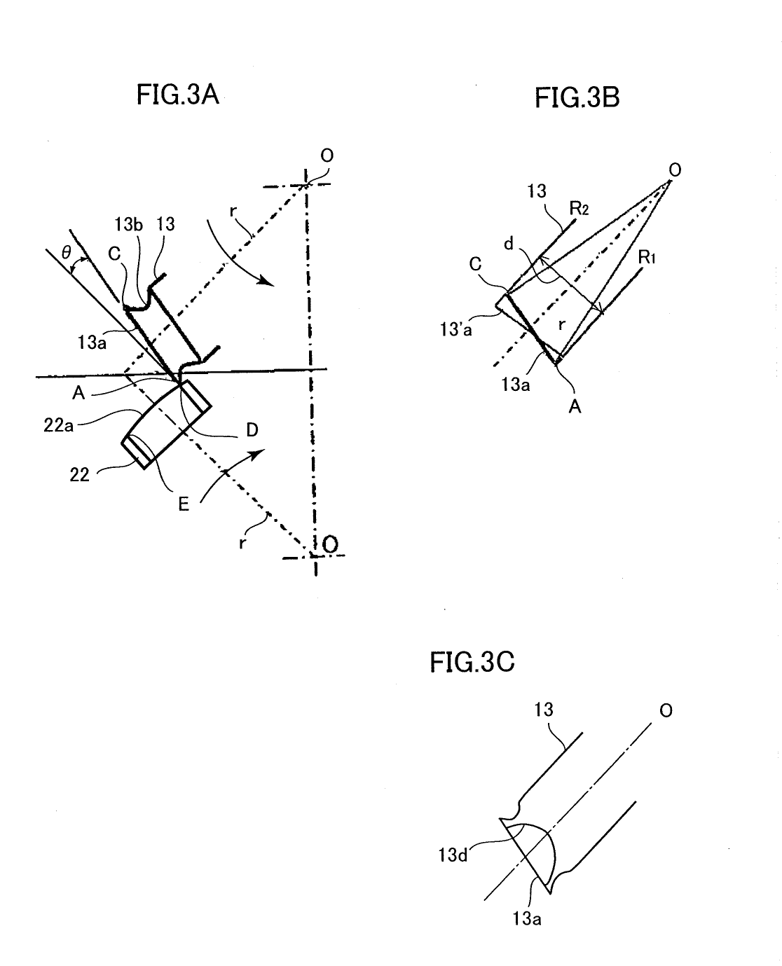

Next, shapes of the punch and die which are the main subjects of the invention will be explained with reference to FIGS. 2 and 3. Each of the punches 13 mounted to the punch shaft 10 has a blade surface 13a, i.e., an edge surface thereof, formed as an inclined surface having a predetermined inclination angle θ with respect to a tangential line in the rotational direction (a line orthogonal to a radial line r connecting the center of the punch shaft and the center of the punch or to a radial line connecting the center of the die shaft and the center of the die in the case of the die) of the shaft 10. That is, the inclined surface is inclined with respect to the outer peripheral surface of the punch shaft or of the die shaft such that the side of a leading edge A in the rotational direction is higher than the side of a trailing edge C (OA>OC) and the inclination angle θ is set within a range of 5° to 15° or more preferably at 10°.

In concrete, when a distance 2R₀ between the axes of rotation (O-O) of the punch and die shafts 10 and 20 is 32 mm (R₀=16 mm), the inclination angle (blade angle) θ=10° and a diameter of the punch d=8 mm for example, while a length R₁ from the rotational axis O of the punch shaft to the blade leading edge A is about 16.5 mm in a case of the prior art blade 13′a, it is about 17.4 mm in a case of the blade 13a of the invention and while the length R₂ from the rotational axis O to the blade trailing edge is about 16.5 mm in the case C of the prior art, it is about 16.0 mm in the case of the invention.

The punch 13 is also provided with a semicircular concave groove 13b formed along the whole circumference around the blade surface 13a in order to prevent interference with the edge (die surface) 22a of the die 22.

The die 22 mounted to the die shaft 20 is formed into a cylindrical shape such that its die surface, i.e., the blade surface, is formed as a circular arc surface 22a whose level, with respect to the outer peripheral surface of the die shaft, at leading and trailing edges D and E are low and whose level at the center part is high and such that it fits with the blade surface 13a of the punch with a predetermined clearance. As shown in FIGS. 2 and 3, the die surface, i.e., the blade of the die, is formed as the cylindrical circular arc surface 22a centering on the rotational axis O of the die shaft 20.

In the beginning of operation, the punch 13 and the die 22 stand by at positions separated from each other as illustrated in the Stand-by Position in FIG. 2. When a sheet of paper P on which an image has been formed is conveyed from the copier or the like to the punching unit 1 in this state, the punch shaft 10 and the die shaft 20 rotate with an equal phase in the directions opposite from each other in accord with the timing of the conveyance. When the leading edges A and D of the blade surface 13a of the punch 13 and the die surface 22a of the die surface 22a begin to engage from each other while interposing the sheet of paper, punching is begun at predetermined position of the sheet. Then, as the both shafts 10 and 20 rotate further, the fitting position of the blade surface 13a of the punch and the die surface 22a of the die moves rearward along the conveyance of the sheet and the punching proceeds (During Punching). The punching ends when a round hole is perforated at the predetermined position of the sheet in a state in which the trailing edge C of the blade surface 13a engages with the trailing edge E of the die surface 22a and then the both trailing edges C and E are separated from each other. Punching chips of the punched holes perforated through the sheet of paper are conveyed to the hollow portion 21a of the die shaft 20 passing through the die hole 22d and the sheet is conveyed as it is to a next step of bookbinding or the like.

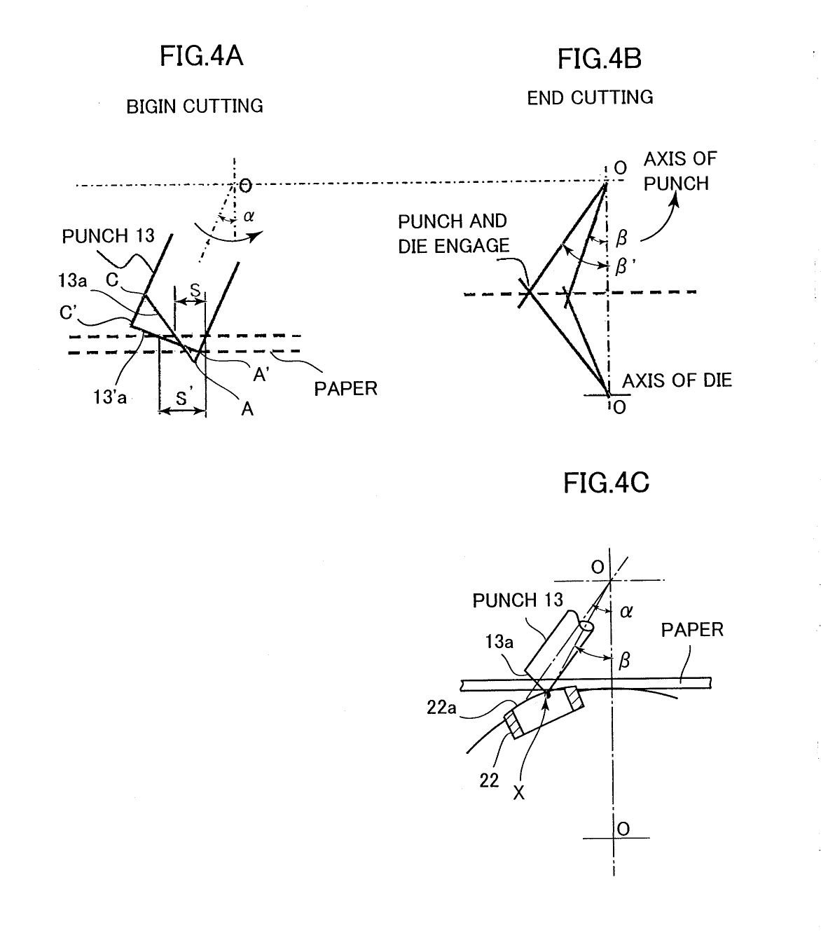

There is a relationship of T∝(S×sin β) between a punching torque T, a cutting length S of the punch blade surface and a cutting position β. Here, as shown in FIG. 4, α is a rotational angle of a center line of the punch 13, i.e., a rotational angle of the punch shaft 10, and the cutting position β represents an angle formed by an intersection point X of the blade surface (inclined surface) 13a of the punch, the die surface (circular arc surface) 22a and the lower surface of the sheet to the rotational axes O-O of the both shafts.

As shown in FIG. 4A, the cutting length S made by the blade surface 13a (AC) of the invention having the blade angle θ is smaller than a cutting length S′ made by the blade surface 13′a of the prior art punch formed along the tangential line (A′C′), i.e., S<S′, in beginning cutting (Begin Punching). Then, as shown in FIG. 4B, the cutting position β of the punch and die of the invention proceeds more and becomes smaller than the cutting position β′ of the prior art punch and die in ending the cutting (End Punching) and accordingly, sin β becomes smaller than sin β′, i.e., sin β<sin β′. As a consequence, it becomes possible to reduce the peaks of the punching torque T both in beginning and ending the cutting.

Further, because the length (OA) of the punch of the invention having the blade angle θ from the rotational axis O of the punch shaft to the leading edge A of the blade surface 13a is longer than that of the prior art (OA′) formed along the tangential line, i.e., OA>OA′, in beginning cutting, the blade surface 13a of the invention starts punching earlier than the blade surface 13a′ of the prior art (the cutting rotational angle β₁ becomes large: see Begin Punching in FIG. 2).

Still more, because the length (OC) of the punch from the rotational axis O of the punch shaft to the trailing edge C of the blade surface 13a of the invention is shorter than that (OC′) of the prior art formed along the tangential line, i.e., OC<OC′, in ending cutting, the end of punching of the blade surface 13a of the invention is delayed as compared to the blade surface 13′ a of the prior art in ending the cutting (the rotational angle β₂ becomes smaller: see End Punching in FIG. 2). As a consequence, a time involved in the punching becomes longer. That is, a rotational angle β₁−β₂ of the punch shaft becomes greater and a cutting length per unit angle becomes small (averaged) to the effect, so that it becomes possible to reduce the peaks of the punching torque T.

Specifically, when the punch whose center distance 2R₀ between the both shafts 10 and 20 is 32 mm, whose diameter is 8 mm and whose blade surface is inclined by the inclination angle θ=10° is used, while the rotational angle (∠OOA) β₁ in beginning punching is 16.02° in the invention, it is 9.84° in the prior art punch and while the rotational angle (∠OOC) β₂ in ending the punching is 3.08° in the invention, it is 9.84° in the prior art punch.

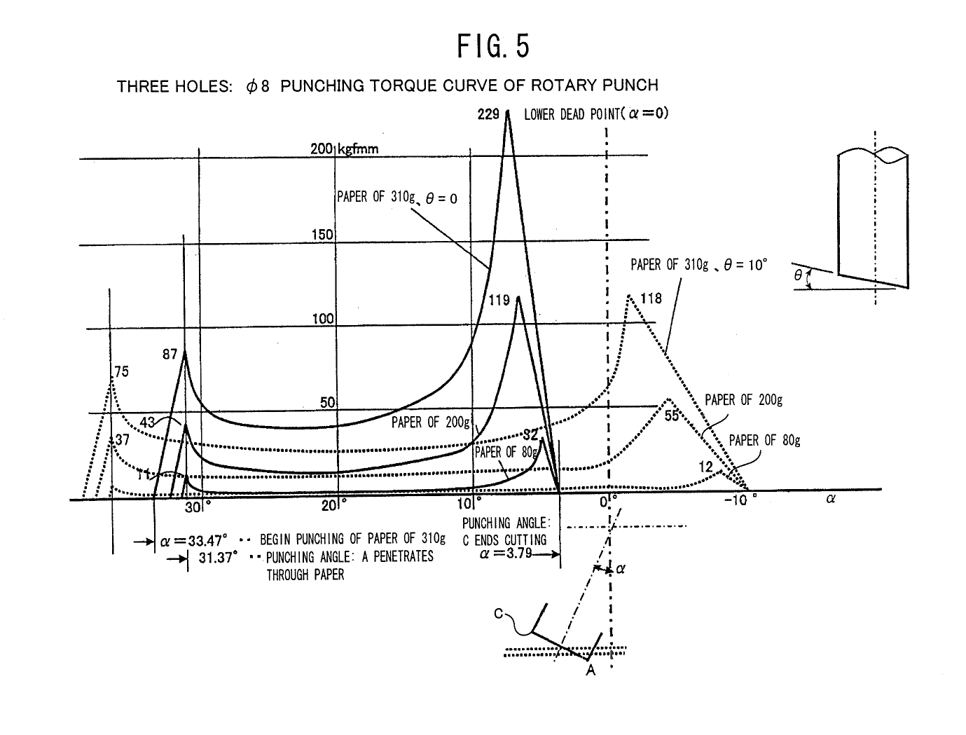

FIG. 5 is a graph comparing punching torque curves of the punch of the invention (indicated by dotted lines) whose blade surface has the blade angle θ=10° and of the prior art (indicated by solid lines) punch whose blade surface is formed along the tangential line (θ=0°) by simulating punching states by various sheets of paper by using the punch whose distance 2R₀ between the rotational axes O-O of the both shafts 10 and 20 is 32 mm and whose diameter is 8 mm. It is noted that the die 22 whose surface is the die surface 22a is used in this simulation (see FIG. 2).

As it is apparent from FIG. 5, peaks of the punching torque decrease in all of the various sheets of paper (310 g, 200 g and 80 g) and the rotational angle α increases by the punch of the invention. In particular, although it is impossible to punch the heavy paper of 310 g for use as a cover sheet or a spine of a book by using the prior art punch whose blade angle θ=0° by the small motor that may be accommodated in a space of the punching unit because the peak is boosted up to 229 kgf·mm, the corresponding peak is 118 kgf·mm by the punch of the invention and the paper may be punched by applying the small motor that may be accommodated in the space of the punching unit.

Since the die surface 22a of the die 22 is formed into the circular arc surface as shown in FIG. 3A, the engagement of the die surface 22a with the blade surface 13a of the punch 13 progresses smoothly as if the blade surface 13a rolls along the die surface 22a during punching as the die shaft 20 rotates. That is, it permits to maintain the shearing angle formed by the blade surface 13a having the blade angle θ and the die surface 22a formed of the circular arc surface in the entire rotational angle α from the beginning to ending of the punching and diversifies the cutting length S in each rotational angle α. That is, the peaks of the punching torque T that is proportional to S×sin β are reduced.

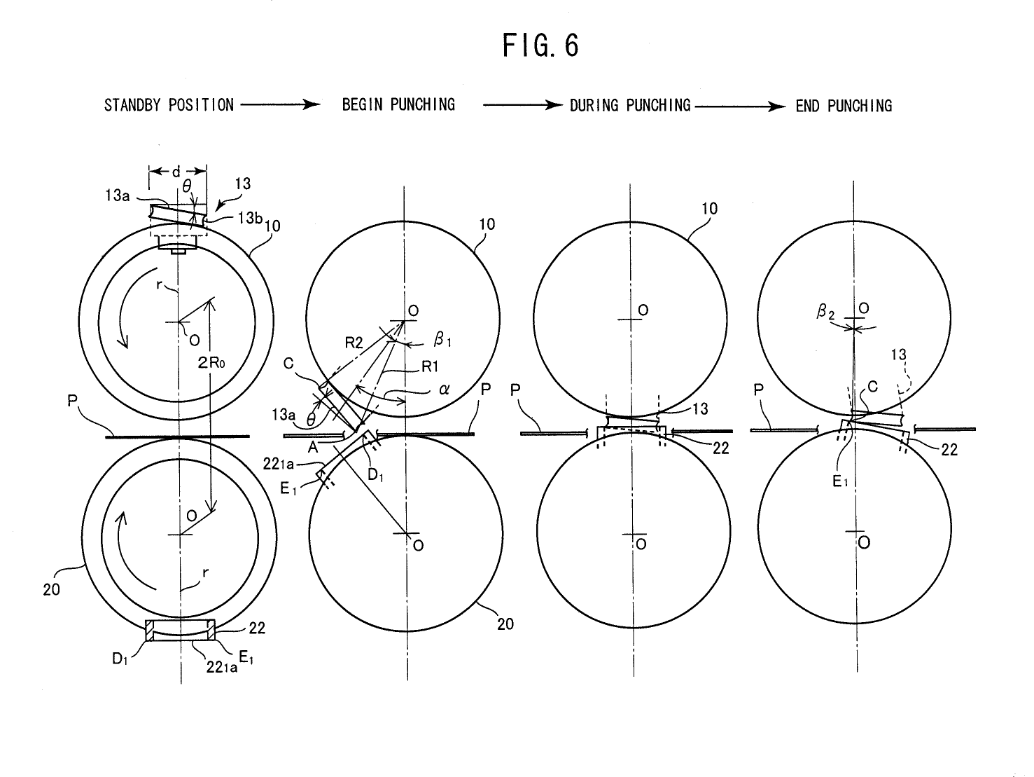

FIG. 6 shows another embodiment in which a die surface of the die 22 is formed into a flat surface (along the tangential line) 22₁a orthogonal to the radial line r of the die shaft 20. Leading and trailing edges D₁ and E₁ of the die surface 22₁a formed into the flat surface are slightly longer (higher) than those of the die surface 22a that is formed into the circular arc surface.

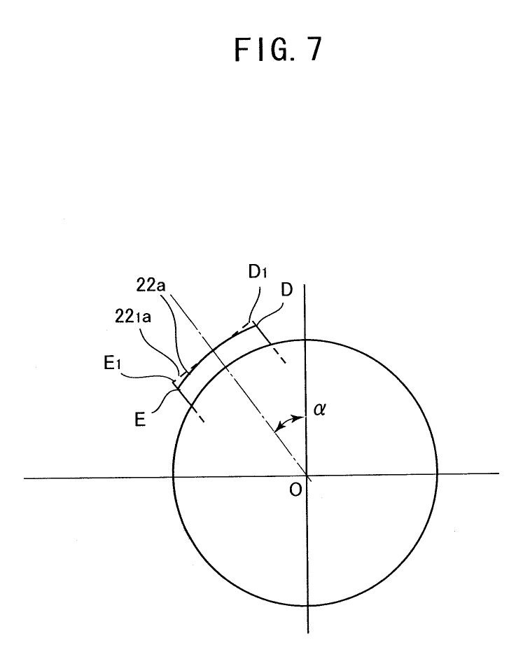

FIG. 7 is a diagram comparing the die surface 22₁a (broken line) formed into the flat surface and the die surface 22a (solid line) formed into the circular arc surface of the die 22. With respect to the lengths between the rotational axis O of the die shaft and the leading edges D and D₁ and the trailing edges E and E₁ of the die surface, those of the leading and trailing edges of the circular arc surface (OD and OE) are shorter than those of the flat surface (OD₁ and OE₁). Accordingly, the rotational angle α in beginning punching becomes small and the rotational angle α in ending punching also becomes small (approaches to a lower dead point α=0), so that the punching rotational angle α of the punch and the die becomes small. It allows precision of a punch hole to be improved by decreasing the clearance required to prevent the interference of the punch and the die.

It is noted that although the decrease of the punching rotational angle α described above is opposite from the diversification of the punching torque T described above, it becomes possible to reduce the peaks of the punching torque or the peak torque in ending cutting in particular by combining the blade surface 13a of the punch 13 having the blade angle θ described above with the die surface 22a formed into the circular arc surface. It allows the high punching quality level to be kept in addition to allowing the unit to be downsized and the heavy paper of 310 g or the like to be punched by reducing the maximum driving torque of the punching unit.

FIG. 3C is a section view showing a punch blade surface according to a different embodiment of the invention. The blade surface formed of the inclined surface has a recess 13d formed at the center part of the blade surface. The recess 13d allows the blade surface 13a to be engaged sharply with the die surfaces 22a and 22₁a and a weight of the edge part of the punch to be reduced. It then permits the punching unit to rotate at high speed and to punch high quality punch holes in combination with the sheet conveying timing of the sped-up copier.

It is noted that although the blade surface 13a of the punch 13 has the predetermined blade angle θ and the die surface 22a of the die 22 is formed as the circular arc surface (or the flat surface 22₁a) in the explanation described above, the die surface may be formed as a predetermined inclined surface and the blade surface of the punch may be formed as a circular arc surface (or a flat surface).

What is claimed is:

1. A punching unit, comprising:
a punch shaft provided with punches on the outer peripheral surface thereof; and
a die shaft provided with dies at positions corresponding to said punches;
said punching unit punching holes through sheets of paper by engaging said punches with said dies by rotating said punch and die shafts in synchronism and in the directions opposite from each other; and
a blade surface of said punch being formed of an inclined surface inclined with respect to a tangential line in the rotational direction of said punch shaft such that the side of a leading edge of said blade surface in the rotational direction is higher than the side of a trailing edge by an inclination angle in a range of 5° to 15°.

2. The punching unit according to claim 1, wherein a die surface of said die is formed into a convex circular arc surface whose level at the center part thereof in the rotational direction is high.

3. The punching unit according to claim 1, wherein the center part of said inclined surface is concaved.

4. The punching unit according to claim 2, wherein the center part of said inclined surface is concaved.

5. The punching unit according to claim 1, wherein said inclination angle is 10°.

6. The punching unit according to claim 4, wherein said inclination angle is 10°.

7. The punching unit according to claim 2, wherein said circular arc surface is a surface of a circular arc centering on the rotational axis of said die shaft.

8. A punching unit, comprising:
a punch shaft provided with punches on the outer peripheral surface thereof; and
a die shaft provided with dies at positions corresponding to said punches;
said punching unit punching holes through sheets of paper by engaging said punches with said dies by rotating said punch and die shafts in synchronism and in the directions opposite from each other; and
a die surface of said die being formed of an inclined surface inclined with respect to a tangential line in the rotational direction of said die shaft such that the side of a leading edge of said die surface in the rotational direction is higher than the side of a trailing edge by an inclination angle in a range of 5° to 15°.
